(19) United States
(12) Patent Application Publication
(10) Pub. No.: US 2005/0117735 A1
(43) Pub. Date: Jun. 2, 2005

(54) Method for load distribution with multiple distribution points

(76) Inventor: James L. Seidman, Naperville, IL (US)

Correspondence Address: Welsh & Katz, Ltd.;Jon P. Christensen, 22nd Floor, 120 South Riverside Plaza, Chicago, IL, 60606, US

(21) Appl. No.: 10/992,496

(22) Filed: Nov. 18, 2004

Related U.S. Application Data
(60) Provisional application No. 60/526,394, filed on Dec. 2, 2003.

(51) Int. Cl. H04M 3/00; H04M 5/00; H04M 7/00

(52) U.S. Cl. 379/265.02; 379/220.01

(57) ABSTRACT

A method and apparatus are provided for processing calls within a call processing system having a plurality of call servers coupled to the public switched telephone network. The method includes the step of determining a number of call resources available within each call server of the plurality of call servers coupled to the public switched telephone network, assigning a portion of a set of numbers to each call server of the plurality of call servers in direct proportion to the resources available within that server, randomly selecting a number from the set and assigning a call to the call processing server with an assigned number that matches the randomly selected number.

The application is a continuation-in-part of U.S. Provisional Patent Application No. 60/526,394 filed on Dec. 2, 2003 (pending).

### FIELD OF THE INVENTION

The field of the invention relates to communication systems and more particularly to call processing systems.

### BACKGROUND OF THE INVENTION

Call processing systems are generally known. Such systems are typically used for anything from telemarketing to voice mail to automatic telephone interfaces for businesses.

Such systems are typically resource intensive. Resource intensive, in this context, usually means that when a resource is assigned to a call, that resource cannot be shared with another call.

For example, a switched circuit through the public switched telephone network (PSTN) cannot be used by more than one user. Similarly, interactive voice response (IVR) units are typically rated for the number of calls that they can handle based upon an assigned number of channels. Once the assigned number of channels is reached, the IVR cannot accept any more callers.

In order to increase capacity, businesses typically add additional call processing units. However, additional call processing units must be connected through a set of trunk connections that are not always balanced in the rate at which calls arrive requiring some kind of load balancing mechanism.

Load balancing in call processing systems is also relatively well-known. However, most described methods share at least two characteristics. Some methods assume that all distribution is being done through a single point of contact, meaning that this point can track distribution assignments. Other methods assume that multiple distribution points have some near instantaneous mechanism for communication their assignment decisions among the distribution points.

The single-point assumption is inherently limited, because it is not suitable for fault-tolerant continuously operating systems. Such systems need to be able to tolerate a distribution point failure without ceasing operation. If a single distribution point is used, and it fails, then the entire system fails.

The methods that assume near instantaneous communication among distribution points can be very inefficient when assignments are made very rapidly. They are also difficult to implement without dedicated hardware-based communication between distribution points. Because of these limitations, a need exists for a method of loading sharing that is more flexible.

### SUMMARY

A method and apparatus are provided for processing calls within a call processing system having a plurality of call servers coupled to the public switched telephone network. The method includes the step of determining a number of call resources available within each call server of the plurality of call servers coupled to the public switched telephone network, assigning a portion of a set of numbers to each call server of the plurality of call servers in direct proportion to the resources available within that server, randomly selecting a number from the set and assigning a call to the call processing server with an assigned number that matches the randomly selected number.

### BRIEF DESCRIPTION OF THE DRAWINGS

FIG. 1 is a block diagram of a load balancing system shown in a context of use under an illustrated embodiment of the invention; and

FIG. 2 is a block diagram of a call director that may be used with the system of FIG. 1.

### DETAILED DESCRIPTION OF AN ILLUSTRATED EMBODIMENT

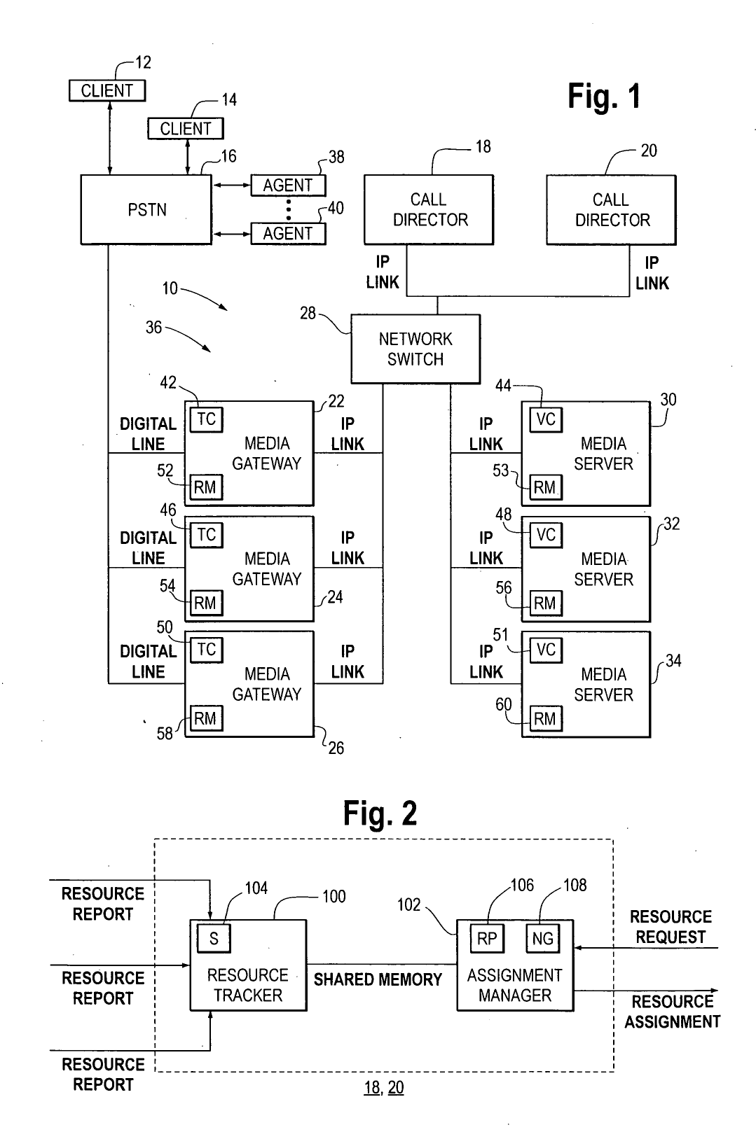

FIG. 1 is a block diagram of a load distribution system 10 under an illustrated embodiment of the invention shown generally in a context of use. Under one illustrated embodiment, the load distribution system may be used in call processing system 36. As shown in FIG. 1, the load processing system 10 may be used within the call processing system 36 to distribute resources (e.g., Interactive Voice Response (IVR) services, switched circuit connections, transcoders, etc.) in response to clients 12, 14 placing calls to the voice processing system 36 through the PSTN 16. However, it should be understood that the system 10 could be used in any resource limited system where resources are distributed by a number of resource controllers from a number of resource providers.

Included within the call processing system 36 may be a number of resource providers that under one illustrated embodiment of the invention may be two or more call servers (e.g., media gateways 22, 24, 26, media servers 30, 32, 34, etc.). Calls arriving through the media gateways 22, 24, 26 are delivered to the media servers 30, 32, 34 through a network switch 28 under the control of two or more resource controllers (e.g., call directors 18, 20).

In effect, the resource providers function to provide resources in response to resource requests. The resource controllers decide which resource provider will provide a resource in response to any particular resource request in such a way as to balance the loading across the resource providers.

The media gateways 22, 24, 26 may function as translation servers by providing a number of transcoders 42, 46, 50 for transcoding between digital information encoded under a time division multiplexed (TDM) format on the PSTN 16 side and an Internet protocol on the network switch 28 side of the gateway 22, 24, 26. Transcoding may occur between a G.711 or other format on one or both sides of the gateways 22, 24, 26. Each gateway 22, 24, 26 may contain sufficient transcoders 42, 46, 50 for trancoding information on up to 48 voice channels.

The media servers 30, 32, 34 function to receive calls and to offer a variety of voice services to clients 12, 14. For example, the media servers 30, 32, 34 may have IVRs 44, 48, 52 that audibly present a number of choices to callers 12, 14. Callers 12, 14 may elect one choice over another either by a spoken response or by activating a predetermined key on a keypad of their telephone. If the media server cannot understand the caller's entries or if the caller 12, 14 requests, the call may be transferred to an agent 38, 40 of the organization using the call processing system 36. Each media server 30, 32, 34 may include sufficient IVRs 44, 48, 52 to provide voice services on up to 48 voice channels.

When used in the call processing system 36, the load distribution system 10 may function as follows. For any given type of resource provider 22, 24, 26, 28, 30, 32, 34, there may be at least one resource monitor 50, 52, 54, 56, 58, 60. The resource monitors 50, 52, 54, 56, 58, 60 are responsible for reporting the number of unused resources available within a particular resource provider 22, 24, 26, 28, 30, 32, 34 to the call directors 18, 20. For example, if 40 of the IVRs 44 of a media server 30 having 48 IRVs were in use during a particular time period, then the resource monitor would return a value of 8 to the call director 18, 20.

In general, a resource report from a resource monitor may contain information on several different types (or groups) of resources. A system will generally have multiple resource monitors 50, 52, 54, 56, 58, 60 for any particular type of resource, with these resource monitors physically located on the components which either contain or are responsible for managing that resource. Each resource monitor sends its availability reports to all distribution points (i.e., resource controllers), which can be done using a multicast or broadcast mechanism, or by sending identical individual reports to distribution points (e.g., call directors 18, 20).

The resource monitors are not necessarily synchronized to any particular reporting interval or as to when they should deliver their availability reports. The distribution points accumulate reports, and can choose to act on them either to distribute resources on a periodic basis or when reports have been received from all resource monitors.

When a distribution point 18, 20 (FIG. 2) receives a call assignment request, the distribution point selects a resource based upon the reports from the resource monitors. First, a summer 104 may calculate the total number of available resources of the requested type by summing the numbers of available resources from all the resource providers. An arbitrary set of numbers may be selected and a number from the set may be associated with each resource of the available resources. A resource processor 106 may then randomly select a number from the set of numbers and assign any new resource request to the resource server having the resource with the associated number that matches the randomly selected number.

For example, a set of numbers may be chosen that includes the sequential set of integers from one to the calculated total number of available resources. A number from the set may be assigned to each of the available resources. A pseudo-random number generator 108 may generate a number between one and the total. The resource processor may then use this pseudo-random number as an index into a list of all available resources to determine where to direct the call. Note that the distribution point may choose a pool of equivalent resources (such as the particular piece of hardware that contains the resource) rather than a particular resource itself.

As a further, more specific example, FIG. 1 shows three media servers 30, 32, 34 that provide IVR services, called SS1, SS2, SS3, respectively. Each has a resource monitor that reports how many IVRs are free. At a given point in time, the distribution points 18, 20 may receive the following reports.

| | |
|---|---|
| SS1 | 5 IVRs available |
| SS2 | 9 IVRs available |
| SS3 | 8 IVRs available |

In this example, the total IVRs would be 22. The set of numbers that could be associated with the IVRs would include the integer values starting at 1 and progressing sequentially to 22. Numbers 1 to 5 would be assigned to the first server, SS1. Numbers 6 to 14 would be assigned to the second server SS2 and 15 to 22 would be assigned to the third server.

When a request for a IVR arrives at a distribution point, the distribution point randomly selects a number from the set of numbers from 1 to 22, inclusive. If the number is between 1 and 5, the resource processor will direct the call to the first server SS1. If the number is between 6 and 14, the resource processor will direct the call to the second server and if the number is between 15 and 22, the call would be directed to the third server SS3.

As a result, the systems with the greatest resource availability will statistically receive the largest number of assignments. However, other systems will still receive a proportionate share of assignments. This allows multiple distribution points to independently make assignments while minimizing the probability of a given resource provider being overloaded.

In the example of FIGS. 1 and 2, calls may be placed by clients 12, 14 to the call processing system 36. The calls may be received by a media gateway 22, 24, 26 and notice of the received call may be sent to a call director 18, 20. The call director 18, 20 may select a media server 30, 32, 34 as described above. First, the resource tracker 100 may sum the available resources from a most recent set of resource reports. The resource processor 106 may assign numbers from a number set to each media server 30, 32, 34 in direct proportion to the available resources at that server 30, 32, 34. A number from the number set may be randomly selected and the server 30, 32, 34 having that assigned number may be identified.

Once the server 30, 32, 34 is identified, the call may be transferred to that server 30, 32, 34. The server 30, 32, 34 may, in turn, select an available IVR 44, 48, 52 to service that call.

The IVR 44, 48, 52 may present options to the client 12, 14 and receive selections from the client 12, 14. For example, the organization using the call processing system 36 may be a merchant and the caller 12, 14 may be a customer checking on an order. The IVR 44, 48, 52 may present a number of call objectives that include the option of checking on an order. The caller 12, 14 may select this option by activating a key on his keypad or simply say “I want to check on my order”. The IVR 44, 48, 52 may ask for a customer identifier and the customer 12, 14 may respond by entering an account number or may simply say his name. The IVR 44, 48, 52 may recognize the identifier and retrieve the requested information.

Upon occasion, the IVR 44, 48, 52 may not be able to help the client 12, 14. The IVR 44, 48, 52 may identify this situation based upon an explicit client entry or by the IVR 44, 48, 52 not being able to identify the customer entries. In this case, the IVR 44, 48, 52 may attempt to transfer the call to an agent 38, 40 of the organization.

In this regard, the IVR 44, 48, 52 may compose and send a transfer request to the call director 18, 20. The call director may attempt to identify a media gateway 22, 24, 26 through which to route the call in an outbound direction towards an agent 38, 40. Once more, the resource tracker 100 may determine the number of available transcoders 42, 46, 50 by summing the transcoders available within each media gateway 22, 24, 26. As above, the call director 18, 20 may provide a set of numbers and assign those numbers to the media gateways 22, 24, 26 in direct proportion to the number of resources available at that gateway 22, 24, 26. A number may be randomly selected from the set and the call routed to the agent 38, 40 through the media server 22, 24, 26 to which the selected number was assigned.

Assigning numbers in direct proportion means that the proportion of resources that exists among the resource providers is the same proportion under which the numbers from the set of numbers are assigned to each resource provider. Under other illustrated embodiments of the invention, an indirect proportion may be used.

To further randomize the process, the random number generator 108 may be allowed to continuously generate numbers. The resource processor 106 may retrieve a random number only when a resource request is received. Operating the number generator 108 on a continuous basis further randomizes the process by allowing the random nature of call arrival to control number selection from the pseudo-random number generation sequence.

A specific embodiment of a method and apparatus for load balancing has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of processing calls within a call processing system having a plurality of call servers coupled to the public switched telephone network, such method comprising:
determining a number of call resources available within each call server of the plurality of call servers coupled to the public switched telephone network;
assigning a portion of a set of numbers to each call server of the plurality of call servers in direct proportion to the resources available within that server;
randomly selecting a number from the set; and
assigning a call to the call processing server with an assigned number that matches the randomly selected number.

2. The method of processing calls as in claim 1 further comprising defining the direct proportion as a one-to-one relationship between the number of resources available within each server and the numbers in the set assigned to the call server.

3. The method of processing calls as in claim 2 further comprising totaling the determined number of call resources available among the plurality of call servers.

4. The method of processing calls as in claim 3 further comprising defining the set of numbers as a sequential set beginning with one and ending with a number equal to the totaled number of call resources among the plurality of call servers.

5. The method of processing calls as in claim 1 wherein the step of randomly selecting a number from the set further comprises receiving a number from a pseudo-random number generator.

6. The method of processing calls as in claim 5 further comprising further randomizing the random number from the pseudo-random number generator by allowing the pseudo-random number generator to continuously generate numbers and only selecting a number from the pseudo-random number generator when a need arises.

7. The method of processing calls as in claim 1 wherein the plurality of call servers further comprises a plurality of interactive voice response units.

8. The method of processing calls as in claim 7 wherein the step of assigning the call further comprises connecting the call to a voice channel of an interactive voice response unit of the plurality of interactive voice response units.

9. The method of assigning calls as in claim 8 further comprising transferring the call from the interactive voice response unit to an agent.

10. The method of processing calls as in claim 9 wherein a second call server of the plurality of call servers further comprises a media gateway.

11. The method of processing calls as in claim 10 wherein step of transferring the call to an agent further comprises repeating the determining, assigning, randomly selecting and assigning steps to identify a media gateway through which to transfer the call.

12. An apparatus for processing calls within a call processing system having a plurality of call servers coupled to the public switched telephone network, such apparatus comprising:
means for determining a number of call resources available within each call server of the plurality of call servers coupled to the public switched telephone network;
means for assigning a portion of a set of numbers to each call server of the plurality of call servers in direct proportion to the resources available within that server;
means for randomly selecting a number from the set; and
means for assigning a call to the call processing server with an assigned number that matches the randomly selected number.

13. The apparatus for processing calls as in claim 12 further comprising defining the direct proportion as a one-to-one relationship between the number of resources available within each server and the numbers in the set assigned to the call server.

14. The apparatus for processing calls as in claim 13 further comprising means for totaling the determined number of call resources available among the plurality of call servers.

15. The apparatus for processing calls as in claim 14 further comprising defining the set of numbers as a sequential set beginning with one and ending with a number equal to the totaled number of call resources among the plurality of call servers.

16. The apparatus for processing calls as in claim 15 wherein the means for randomly selecting a number from the set further comprises means for receiving a number from a pseudo-random number generator.

17. The apparatus for processing calls as in claim 16 further comprising means for further randomizing the random number from the pseudo-random number generator by allowing the pseudo-random number generator to continuously generate numbers and only selecting a number from the pseudo-random number generator when a need arises.

18. The apparatus for processing calls as in claim 12 wherein the plurality of call servers further comprises a plurality of interactive voice response units.

19. The apparatus for processing calls as in claim 18 wherein the means for assigning the call further comprises means for connecting the call to a voice channel of an interactive voice response unit of the plurality of interactive voice response units.

20. The apparatus for assigning calls as in claim 19 further comprising means for transferring the call from the interactive voice response unit to an agent.

21. The apparatus for processing calls as in claim 20 wherein a second call server of the plurality of call servers further comprises a media gateway.

22. The apparatus for processing calls as in claim 21 wherein means for transferring the call to an agent further comprises means for repeating the determining, assigning, randomly selecting and assigning steps to identify a media gateway through which to transfer the call.

23. An apparatus for processing calls within a call processing system having a plurality of call servers coupled to the public switched telephone network, such apparatus comprising:
a resource monitor that determines a number of call resources available within each call server of the plurality of call servers coupled to the public switched telephone network;
a resource processor that assigns a portion of a set of numbers to each call server of the plurality of call servers in direct proportion to the resources available within that server;
a pseudo-random number generator that randomly selects a number from the set; and
said resource processor being further adapted to assign a call to the call processing server with an assigned number that matches the randomly selected number.

24. The apparatus for processing calls as in claim 23 further comprising defining the direct proportion as a one-to-one relationship between the number of resources available within each server and the numbers in the set assigned to the call server.

25. The apparatus for processing calls as in claim 24 further comprising a summer that totals the determined number of call resources available among the plurality of call servers.

26. The apparatus for processing calls as in claim 25 further comprising defining the set of numbers as a sequential set beginning with one and ending with a number equal to the totaled number of call resources among the plurality of call servers.

27. The apparatus for processing calls as in claim 23 wherein the plurality of call servers further comprises a plurality of interactive voice response units.

28. The apparatus for processing calls as in claim 27 wherein the call processor further comprises a switch that connects the call to a voice channel of an interactive voice response unit of the plurality of interactive voice response units.

29. A method of selecting a resource within one of a plurality of call processing servers coupled to the public switched telephone network, such method comprising:
determining a number of call processing resources available within each call processing server of the plurality of call processing servers;
totaling the determined number of available call processing resources among the plurality of call processing servers;
allocating a portion of the numbers between zero and the total number to each call processing server of the plurality of call processing servers in direct proportion to the resources available within that server;
randomly selecting a number between zero and the total determined number; and
assigning a call to the call processing server with an allocated number that matches the randomly selected number.

30. A method of processing resource requests within a load distribution system having a plurality of resource providers, such method comprising:
determining a number of resources available within each resource provider of the plurality of resource providers;
assigning a portion of a set of numbers to each resource provider of the plurality of resource providers in direct proportion to the resources available within that resource provider;
randomly selecting a number from the set; and
assigning a resource request to the resource provider of the plurality of resource provider with an assigned number that matches the randomly selected number.

31. The method of processing resource requests as in claim 30 further comprising defining the direct proportion as a one-to-one relationship between the number of resources available within each resource provider and the numbers in the set assigned to the resource provider.

32. The method of processing resource requests as in claim 31 further comprising totaling the determined number of resources available among the plurality of resource providers.

33. The method of processing resource requests as in claim 32 further comprising defining the set of numbers as a sequential set beginning with one and ending with a number equal to the totaled number of resources among the plurality of resource providers.

34. The method of processing resource requests as in claim 30 wherein the step of randomly selecting a number from the set further comprises receiving a number from a pseudo-random number generator.

35. The method of processing resource requests as in claim 34 further comprising further randomizing the random number from the pseudo-random number generator by allowing the pseudo-random number generator to continuously generate numbers and only selecting a number from the pseudo-random number generator when a need arises.
